(19) United States
(12) Patent Application Publication
(10) Pub. No.: US 2026/0338560 A1
(43) Pub. Date: Oct. 29, 2026

(54) NAVIGATION METHOD

(71) Applicant: BAIDU (CHINA) CO., LTD., SHANGHAI (CN)

(72) Inventors: Ning YANG, Shanghai (CN); You LI, Shanghai (CN); Jinming MU, Shanghai (CN); Wenbo SHAN, Shanghai (CN); Hailu JIA, Shanghai (CN); Jingyuan CHEN, Shanghai (CN)

(21) Appl. No.: 19/705,455

(22) Filed: Jun. 11, 2026

(30) Foreign Application Priority Data
Jun. 12, 2025 (CN) 202510788276.9

(51) Int. Cl. G01C 21/30

(52) U.S. Cl. CPC G01C 21/30

(57) ABSTRACT

A method is provided. An implementation solution includes: performing, in response to receiving an off-route confirmation request, road-level map matching and lane-level map matching based on a sequence of trajectory points in the off-route confirmation request, to correspondingly obtain a road-level matching result and a lane-level matching result; determining whether the sequence of trajectory points meets a preset quality requirement based on a trajectory point distribution feature of the sequence of trajectory points relative to the lane-level path; updating the road-level matching result based on the lane-level matching result in response to determining that the sequence of trajectory points meets the preset quality requirement, and in response to determining that the lane-level matching result and the road-level matching result are inconsistent; and obtaining an off-route confirmation result based on the road-level matching result updated and a current navigation route.

### CROSS REFERENCE TO RELATED APPLICATION

This application claims priority to Chinese patent application No. 202510788276.9 filed on Jun. 12, 2025, the contents of which are hereby incorporated by reference in their entirety for all purposes.

### TECHNICAL FIELD

The present disclosure relates to the technical field of computers, in particular to the technical fields such as navigation and high-definition maps, and specifically to a navigation method, an electronic device, and a non-transient computer-readable storage medium.

### BACKGROUND

With the continuous development of technology, smart terminals have become indispensable devices in people's daily lives. Users can install various types of applications on smart terminals to meet their diverse needs. Travel-related applications, such as map navigation applications, are widely used. Generally, map navigation applications can not only plan a navigation route from a starting point to a destination, but also guide a navigated object along the navigation route based on a location of the navigated object. Furthermore, to make the navigated object aware of its location on the navigation route, the location of the navigated object is typically marked on the navigation route.

The approaches described in this section are not necessarily those that have been previously conceived or pursued. Unless otherwise indicated, it should not be assumed that any of the approaches described in this section qualify as prior art merely by virtue of their inclusion in this section. Similarly, issues mentioned in this section should not be assumed to have been recognized in any prior art, unless otherwise indicated.

### SUMMARY

The present disclosure provides a navigation method, an electronic device, and a non-transient computer-readable storage medium.

According to an aspect of the present disclosure, a navigation method is provided. The navigation method includes: performing, in response to receiving an off-route confirmation request, road-level map matching and lane-level map matching based on a sequence of trajectory points in the off-route confirmation request, to correspondingly obtain a road-level matching result and a lane-level matching result, where the lane-level matching result includes a lane-level path matched to the sequence of trajectory points; determining whether the sequence of trajectory points meets a preset quality requirement based on a trajectory point distribution feature of the sequence of trajectory points relative to the lane-level path; updating the road-level matching result based on the lane-level matching result in response to determining that the sequence of trajectory points meets the preset quality requirement, and in response to determining that the lane-level matching result and the road-level matching result are inconsistent; and obtaining an off-route confirmation result based on the road-level matching result updated and a current navigation route.

According to another aspect of the present disclosure, an electronic device is provided. The electronic device includes: at least one processor; and a memory communicatively connected to the at least one processor, wherein the memory storing one or more programs configured to be executed by the one or more processors, the one or more programs including instructions for: performing, in response to receiving an off-route confirmation request, road-level map matching and lane-level map matching based on a sequence of trajectory points in the off-route confirmation request, to correspondingly obtain a road-level matching result and a lane-level matching result, wherein the lane-level matching result comprises a lane-level path matched to the sequence of trajectory points; determining whether the sequence of trajectory points meets a preset quality requirement based on a trajectory point distribution feature of the sequence of trajectory points relative to the lane-level path; updating the road-level matching result based on the lane-level matching result in response to determining that the sequence of trajectory points meets the preset quality requirement, and in response to determining that the lane-level matching result and the road-level matching result are inconsistent; and obtaining an off-route confirmation result based on the road-level matching result updated and a current navigation route.

According to another aspect of the present disclosure, a non-transitory computer-readable storage medium is provided. The non-transient computer-readable storage medium stores one or more programs comprising instructions that, when executed by one or more processors of a computing device, cause the computing device to perform operations comprising: performing, in response to receiving an off-route confirmation request, road-level map matching and lane-level map matching based on a sequence of trajectory points in the off-route confirmation request, to correspondingly obtain a road-level matching result and a lane-level matching result, wherein the lane-level matching result comprises a lane-level path matched to the sequence of trajectory points; determining whether the sequence of trajectory points meets a preset quality requirement based on a trajectory point distribution feature of the sequence of trajectory points relative to the lane-level path; updating the road-level matching result based on the lane-level matching result in response to determining that the sequence of trajectory points meets the preset quality requirement, and in response to determining that the lane-level matching result and the road-level matching result are inconsistent; and obtaining an off-route confirmation result based on the road-level matching result updated and a current navigation route.

It should be understood that the descriptions in this section are not intended to identify critical or essential features of the embodiments of the present disclosure, nor are they intended to limit the scope of the present disclosure. Other features of the present disclosure will be readily understood from the following description.

### BRIEF DESCRIPTIONS OF THE DRAWINGS

The accompanying drawings illustratively depict example embodiments and form a part of the specification, serving to illustrate example implementations of the embodiments together with the written description of the specification. The embodiments shown are intended for illustrative purposes only and do not limit the scope of the claims. Throughout the accompanying drawings, the same reference numerals denote similar, but not necessarily identical, elements.

FIG. 1 is a schematic diagram of an example system in which various methods described herein can be implemented according to an embodiment of the present disclosure;

FIG. 2 is a flowchart of a navigation method according to an embodiment of the present disclosure;

FIG. 3 is a flowchart of obtaining an off-route confirmation result according to an embodiment of the present disclosure;

FIG. 4 is an architecture diagram of an off-route confirmation system according to an example embodiment of the present disclosure;

FIG. 5 is a structural block diagram of a navigation apparatus according to an embodiment of the present disclosure; and

FIG. 6 is a structural block diagram of an example electronic device that can be used to implement an embodiment of the present disclosure.

### DETAILED DESCRIPTION OF EMBODIMENTS

The following description of example embodiments of the present disclosure are made with reference to the accompanying drawings, which includes various details of the embodiments of the present disclosure to aid understanding and should be considered as merely illustrative. Therefore, those of ordinary skill in the art should be aware that various changes and modifications can be made to the embodiments described herein, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one element from another. In some examples, a first element and a second element may refer to a same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of the listed terms.

The embodiments of the present disclosure will be described below in detail with reference to the accompanying drawings.

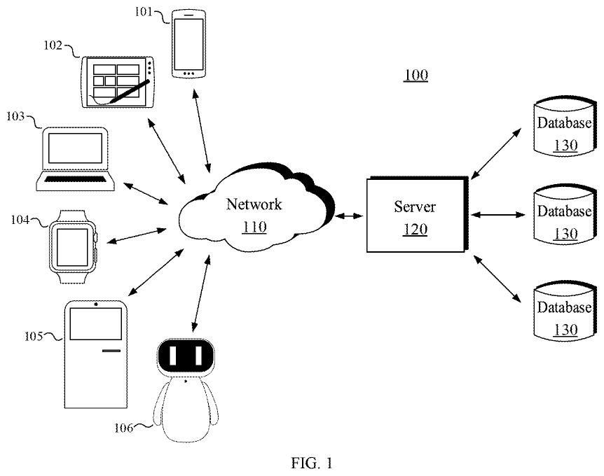

FIG. 1 is a schematic diagram of an example system 100 in which various methods and apparatuses described herein can be implemented according to an embodiment of the present disclosure. Referring to FIG. 1, the system 100 includes one or more client devices 101, 102, 103, 104, 105, and 106, a server 120, and one or more communication networks 110 that couple the one or more client devices to the server 120. The client devices 101, 102, 103, 104, 105, and 106 may be configured to execute one or more applications.

In an embodiment of the present disclosure, the server 120 can run one or more services or software applications that enable a navigation method according to the present disclosure to be performed.

In some embodiments, the server 120 may further provide other services or software applications that may include a non-virtual environment and a virtual environment. In some embodiments, these services may be provided as web-based services or cloud services, for example, provided to a user of the client devices 101, 102, 103, 104, 105, and/or 106 in a software-as-a-service (SaaS) model.

In the configuration shown in FIG. 1, the server 120 may include one or more components that implement functions performed by the server 120. These components may include software components, hardware components, or a combination thereof that can be executed by one or more processors. The user operating the client devices 101, 102, 103, 104, 105, and/or 106 may sequentially use one or more client applications to interact with the server 120, to use the services provided by these components. It should be understood that various different system configurations are possible, and may be different from that of the system 100. Therefore, FIG. 1 is an example of the system for implementing various methods described herein, and is not intended to be limiting.

The user may use the client devices 101, 102, 103, 104, 105, and/or 106 to obtain a navigation route. The client device may provide an interface that enables the user of the client device to interact with the client device. The client device may further output information to the user via the interface. Although FIG. 1 shows only six client devices, those skilled in the art will understand that any number of client devices can be supported in the present disclosure.

The client devices 101, 102, 103, 104, 105, and/or 106 may include various types of computer devices, such as a portable handheld device, a general-purpose computer (such as a personal computer and a laptop computer), a workstation computer, a wearable device, a smart screen device, a self-service terminal device, a service robot, a gaming system, a thin client, various messaging devices, and a sensor or other sensing devices. These computer devices can run various types and versions of software applications and operating systems, such as MICROSOFT Windows, APPLE iOS, a UNIX-like operating system, and a Linux or Linux-like operating system (e.g., GOOGLE Chrome OS), or include various mobile operating systems, such as MICROSOFT Windows Mobile OS, iOS, Windows Phone, and Android. The portable handheld device may include a cellular phone, a smartphone, a tablet computer, a personal digital assistant (PDA), etc. The wearable device may include a head-mounted display (such as smart glasses) and other devices. The gaming system may include various handheld gaming devices, Internet-enabled gaming devices, etc. The client device can execute various applications, such as various Internet-related applications, communication applications (e.g., email applications), and short message service (SMS) applications, and can use various communication protocols.

The network 110 may be any type of network well known to those skilled in the art, and may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a blockchain network, a public switched telephone network (PSTN), an infrared network, a wireless network (e.g., Bluetooth or Wi-Fi), and/or any combination of these and/or other networks.

The server 120 may include one or more general-purpose computers, a dedicated server computer (e.g., a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures related to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any one of the above-mentioned operating systems and any commercially available server operating system. The server 120 can also run any one of various additional server applications and/or middle-tier applications, including an HTTP server, an FTP server, a CGI server, a JAVA server, a database server, etc.

In some implementations, the server 120 may include one or more applications to analyze and merge data feeds and/or event updates received from users of the client devices 101, 102, 103, 104, 105, and/or 106. The server 120 may further include one or more applications to display the data feeds and/or real-time events via one or more display devices of the client devices 101, 102, 103, 104, 105, and/or 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 may further include one or more databases 130. In some embodiments, these databases can be used to store data and other information. For example, one or more of the databases 130 can be configured to store information such as an audio file and a video file. The databases 130 may reside in various positions. For example, a database used by the server 120 may be locally in the server 120, or may be remote from the server 120 and may communicate with the server 120 via a network-based or dedicated connection. The database 130 may be of different types. In some embodiments, the database used by the server 120 may be, for example, a relational database. One or more of these databases can store, update, and retrieve data from or to the database, in response to a command.

In some embodiments, one or more of the databases 130 may further be used by an application to store application data. The database used by the application may be of different types, for example, may be a key-value repository, an object repository, or a regular repository backed by a file system.

The system 100 of FIG. 1 may be configured and operated in various manners, so that the various methods and apparatuses described according to the present disclosure can be applied.

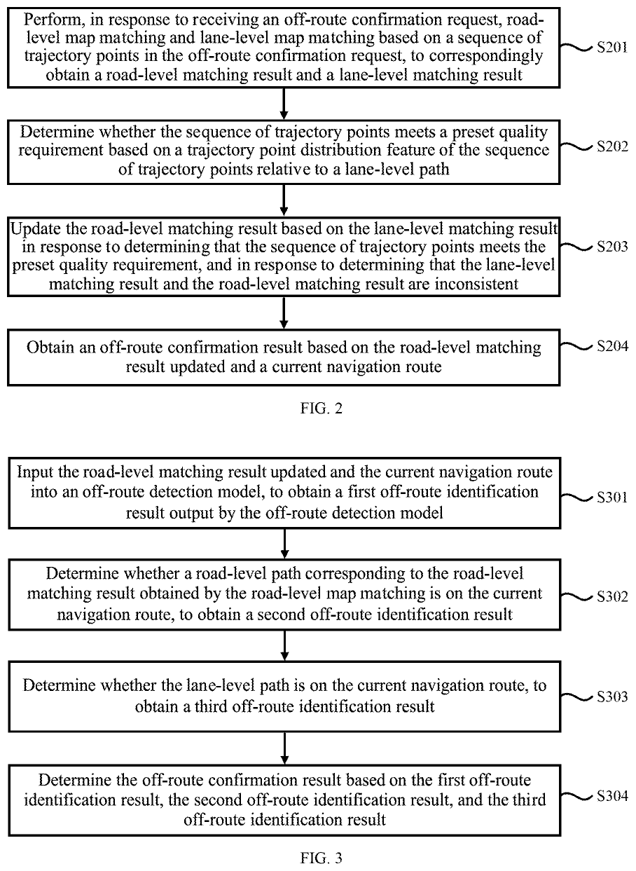

According to some embodiments, as shown in FIG. 2, a navigation method is provided. The navigation method includes: step S201 of performing, in response to receiving an off-route confirmation request, road-level map matching and lane-level map matching based on a sequence of trajectory points in the off-route confirmation request, to correspondingly obtain a road-level matching result and a lane-level matching result, where the lane-level matching result includes a lane-level path matched to the sequence of trajectory points; step S202 of determining whether the sequence of trajectory points meets a preset quality requirement based on a trajectory point distribution feature of the sequence of trajectory points relative to the lane-level path; step S203 of updating the road-level matching result based on the lane-level matching result in response to determining that the sequence of trajectory points meets the preset quality requirement, and in response to determining that the lane-level matching result and the road-level matching result are inconsistent; and step S204 of obtaining an off-route confirmation result based on the road-level matching result updated and a current navigation route.

Thus, after obtaining the road-level matching result and the lane-level matching result, the sequence of trajectory points is first subjected to quality inspection based on the trajectory point distribution feature of the sequence of trajectory points relative to the matched lane-level path. This allows for an indirect determination of the accuracy of the current lane-level matching result. When the sequence of trajectory points meets the preset quality requirement (i.e., the lane-level matching result is accurate), the road-level matching result is updated based on the lane-level matching result. Then, off-route confirmation is performed based on the road-level matching result updated, thereby improving the accuracy of the off-route confirmation.

In some embodiments, a requester of the off-route confirmation request may be a client having a navigation application installed thereon. When providing navigation services for a navigated object through the navigation application, the client may perform preliminary off-route detection based on real-time positioning information. When it is detected that the object may be off-route, the client automatically sends an off-route confirmation request to a cloud, allowing the cloud to perform further off-route confirmation. If it is confirmed that the navigated object is already off-route, the navigated object may be rerouted based on a current location of the navigated object. If it is confirmed that the navigated object is not off-route, the off-route confirmation request may be rejected (by sending a message indicating that the navigated object is not off-route to the client), to continue navigating for the navigated object based on the current navigation route.

In some embodiments, the off-route confirmation request may further include a sequence of latest trajectory points of the navigated object, which may include a plurality of trajectory points. After the off-route confirmation request is received, road-level map matching and lane-level map matching may be first performed based on the sequence of trajectory points in the request, to respectively obtain a road-level matching result and a lane-level matching result corresponding to the sequence of trajectory points.

The road-level map matching may involve performing map matching by using road-level road network data and the sequence of trajectory points, and the obtained road-level matching result may include a road-level path matched to the sequence of trajectory points. The lane-level map matching may involve performing map matching by using lane-level road network data and the sequence of trajectory points, and the obtained lane-level matching result may include a lane-level path matched to the sequence of trajectory points.

The map matching may be implemented based on a hidden Markov model (HMM).

In the road-level map matching, the plurality of trajectory points in the sequence of trajectory points and the road-level road network data may be input into a trained HMM model, such that the model outputs at least one candidate road matched to each trajectory point and a matching confidence level (i.e., emission probability) of each candidate road. The road-level path corresponding to the sequence of trajectory points is obtained based on the aforementioned information. Similarly, in the lane-level map matching, the plurality of trajectory points in the sequence of trajectory points and the lane-level road network data may be input into a trained HMM model, such that the model outputs at least one candidate lane matched to each trajectory point and a matching confidence level (i.e., emission probability) of each candidate lane. The lane-level path corresponding to the sequence of trajectory points is obtained based on the aforementioned information.

In some embodiments, the lane-level path may be obtained by connecting centerlines of lane segments matched to the plurality of trajectory points, and similarly, the road-level path may be obtained by connecting centerlines of road segments matched to the plurality of trajectory points.

After the road-level matching result and the lane-level matching result are obtained, the trajectory point distribution feature of the sequence of trajectory points relative to the lane-level path (for example, a degree of dispersion of the trajectory points distributed relative to the lane-level path) may be obtained, and then whether the sequence of trajectory points meets the preset quality requirement is determined based on the trajectory point distribution feature.

In some embodiments, the trajectory point distribution feature may include a first feature corresponding to each trajectory point in the sequence of trajectory points, and the first feature may include at least one of: a distance between the trajectory point and the lane-level path, or an included angle between a trajectory line formed at the trajectory point by the sequence of trajectory points and the lane-level path.

Thus, by performing quality inspection on the first feature of each trajectory point in the sequence of trajectory points one by one, it is possible to further improve the accuracy of the lane-level matching result, which in turn further improves the accuracy of off-route confirmation.

In some embodiments, the preset quality requirement may include that the first feature corresponding to each trajectory point in the sequence of trajectory points meets a first quality requirement. The first feature corresponding to the trajectory point is considered to meet the first quality requirement if at least one of the following conditions is met: a distance between the trajectory point and the lane-level path being less than a first preset distance; and an included angle between a corresponding trajectory line at the trajectory point (for example, a connecting line between the trajectory point and an adjacent trajectory point) and the lane-level path being less than a preset angle.

In some example embodiments, in response to the distance between each trajectory point and the lane-level path being less than the first preset distance, and the included angle between the corresponding trajectory line at each trajectory point and the lane-level path being less than the preset angle, the first feature corresponding to each trajectory point may be considered to meet the first quality requirement. Then, it may be determined that the sequence of trajectory points meets the preset quality requirement, and that the accuracy of the lane-level matching result meets the requirement.

It can be understood that the setting of the first quality requirement can be determined according to actual needs, which is not limited herein.

In some embodiments, determining whether the sequence of trajectory points meets the preset quality requirement based on the trajectory point distribution feature of the sequence of trajectory points relative to the lane-level path may include: determining whether the sequence of trajectory points meets the preset quality requirement based on the trajectory point distribution feature and a second feature of a last trajectory point in the sequence of trajectory points, where the second feature includes at least one of: a matching confidence level of the last trajectory point with a lane matched to the last trajectory point in the lane-level path, a lane attribute of the lane, or connectivity between the last trajectory point and a preceding trajectory point of the last trajectory point.

Thus, by further performing quality inspection on the second feature of the last trajectory point in the sequence of trajectory points, it is possible to further improve the accuracy of the lane-level matching result, which in turn further improves the accuracy of the off-route confirmation.

The last trajectory point may be the final trajectory point in the sequence of trajectory points. The matching confidence level may be the matching confidence level of the last trajectory point with the lane output by the HMM model during the execution of the lane-level map matching. The lane attribute may include, for example, whether the lane is a left-turn lane, a right-turn lane, or a straight lane, whether the lane prohibits a U-turn, whether the lane is a main road or a side road, whether the lane belongs to an internal road in an area such as a parking lot, etc. The connectivity between the last trajectory point and the preceding trajectory point may be determined by checking a time difference and a spatial distance from a previous trajectory point. For example, when the time difference is greater than a preset duration or the spatial distance is greater than a preset distance, the connectivity is considered to be abnormal.

In some example embodiments, determining whether the sequence of trajectory points meets the preset quality requirement based on the trajectory point distribution feature and the second feature of the last trajectory point in the sequence of trajectory points may include: determining whether the first feature corresponding to each trajectory point in the sequence of trajectory points meets the first quality requirement; and meanwhile, determining whether the second feature of the last trajectory point meets a second quality requirement. If both requirements are met, the sequence of trajectory points is considered to meet the preset quality requirement, and the accuracy of the lane-level matching result is considered to meet the requirement.

In some embodiments, the second feature of the last trajectory point may be considered to meet the second quality requirement if at least one of the following is met: the matching confidence level of the last trajectory point with the lane being greater than a preset threshold, the lane attribute indicating that the lane is not an internal road, and the last trajectory point being connected to the preceding trajectory point.

In some example embodiments, the second feature of the last trajectory point may be considered to meet the second quality requirement in response to the matching confidence level of the last trajectory point with the lane being greater than the preset threshold, the lane attribute indicating that the lane at the last trajectory point is not an internal road, and the last trajectory point being connected to the preceding trajectory point.

It can be understood that the setting of the second quality requirement can be determined according to actual needs, which is not limited herein.

After it is determined that the sequence of trajectory points meets the preset quality requirement, if it is further determined that the lane-level matching result and the road-level matching result are inconsistent, the road-level matching result may be updated based on the lane-level matching result.

In some embodiments, whether the lane-level matching result and the road-level matching result are consistent may be determined by determining whether the lane-level path and the road-level path correspond to a same path.

In some embodiments, determining whether the lane-level matching result and the road-level matching result are consistent may include: determining whether a lane matched to a last trajectory point in the sequence of trajectory points is on a road matched to the last trajectory point at the last trajectory point, to determine whether the lane-level matching result and the road-level matching result are consistent.

Thus, by only determining the consistency of the matching results of the last trajectory point, it is possible to simplify the determination logic of the overall consistency between the lane-level matching result and the road-level matching result, thereby saving computing resources while ensuring the determination accuracy.

In some embodiments, updating the road-level matching result based on the lane-level matching result may involve mapping data of each lane dimension in the lane-level matching result to a road-level road network, thereby obtaining the road-level matching result updated.

Subsequently, the off-route confirmation result may be obtained based on the road-level matching result updated and the current navigation route.

In some embodiments, the lane-level path may be mapped to the road-level path, and whether the navigated object is off-route is determined by determining whether the road-level path is consistent with the navigation route.

In some embodiments, alternatively, all data in the lane-level matching result (including the lane matched to each trajectory point and the matching confidence level) may be mapped to the road-level matching result updated, and the data contained in the road-level matching result updated and the current navigation route are input into a pre-trained off-route confirmation model, allowing the off-route confirmation result to be output based on the off-route confirmation model. The off-route confirmation model may be obtained by training with sample data containing road-level matching results of sample trajectories, sample navigation routes, and labels indicating whether there is an off-route.

In some embodiments, as shown in FIG. 3, obtaining the off-route confirmation result based on the road-level matching result updated and the current navigation route may include: step S301 of inputting the road-level matching result updated and the current navigation route into an off-route detection model, to obtain a first off-route identification result output by the off-route detection model; step S302 of determining whether a road-level path corresponding to the road-level matching result obtained by the road-level map matching is on the current navigation route, to obtain a second off-route identification result; step S303 of determining whether the lane-level path is on the current navigation route, to obtain a third off-route identification result; and step S304 of determining the off-route confirmation result based on the first off-route identification result, the second off-route identification result, and the third off-route identification result.

Thus, the three off-route identification results are obtained from the three paths, respectively, and the final off-route confirmation result is obtained based on the three off-route identification results, thereby further improving the accuracy of the off-route confirmation result.

In some embodiments, determining the off-route confirmation result based on the first off-route identification result, the second off-route identification result, and the third off-route identification result may involve, if at least two of the first off-route identification result, the second off-route identification result, or the third off-route identification result indicate that there is no off-route, considering the navigated object not to be off-route, and confirming no off-route as the off-route confirmation result.

In some embodiments, determining the off-route confirmation result based on the first off-route identification result, the second off-route identification result, and the third off-route identification result may include: determining the off-route confirmation result as indicating that a navigated object is not off-route in response to any of the first off-route identification result, the second off-route identification result, or the third off-route identification result indicating that the navigated object has not deviated from the current navigation route; otherwise, determining the off-route confirmation result as indicating that the navigated object is already off-route.

Thus, misidentification of off-route can be minimized, thereby improving the accuracy of the off-route confirmation result.

In some embodiments, the navigation method may further include: obtaining the off-route confirmation result based on the road-level matching result obtained by the road-level map matching and the current navigation route in response to determining that the sequence of trajectory points does not meet the preset quality requirement.

Thus, if the sequence of trajectory points fails to pass the quality inspection, it indicates that the accuracy of the corresponding lane-level matching result is not high. In this case, directly using the road-level matching result obtained by the road-level map matching (i.e., initial road-level matching result) for off-route confirmation can maximize the accuracy of the off-route confirmation.

In some embodiments, obtaining the off-route confirmation result based on the road-level matching result obtained by the road-level map matching and the current navigation route may include determining whether a road-level path corresponding to the road-level matching result obtained by the road-level map matching is on the current navigation route, to obtain the off-route confirmation result.

In some embodiments, obtaining the off-route confirmation result based on the road-level matching result obtained by the road-level map matching and the current navigation route may include inputting the road-level matching result obtained by the road-level map matching and the current navigation route into a pre-trained off-route identification model, allowing the off-route identification model to output the off-route confirmation result.

In some embodiments, obtaining the off-route confirmation result based on the road-level matching result obtained by the road-level map matching and the current navigation route may include determining whether a road-level path corresponding to the road-level matching result obtained by the road-level map matching is on the current navigation route, to obtain a fourth off-route identification result; inputting the road-level matching result obtained by the road-level map matching and the current navigation route into a pre-trained off-route identification model, allowing the off-route identification model to output a fifth off-route identification result; and determining the off-route confirmation result as indicating that a navigated object is not off-route in response to either of the fourth off-route identification result or the fifth off-route identification result indicating that the navigated object has not deviated from the current navigation route; otherwise, determining the off-route confirmation result as indicating that the navigated object is already off-route.

In some embodiments, the navigation method may further include: sending the off-route confirmation result to a requester of the off-route confirmation request in response to the off-route confirmation result indicating that a navigated object has not deviated from the current navigation route.

Thus, when it is confirmed that the navigated object is not off-route, the result is returned to the requester, thereby preventing an off-route prompt from the requester (client) and allowing the requester to continue navigating along the current navigation route, thus avoiding affecting user experience.

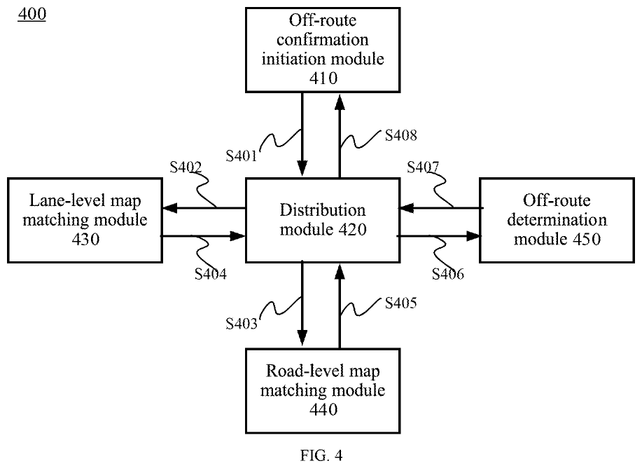

FIG. 4 is an architecture diagram of an off-route confirmation system 400 according to an example embodiment of the present disclosure.

In some example embodiments, as shown in FIG. 4, the off-route confirmation system may include an off-route confirmation initiation module 410, a distribution module 420, a lane-level map matching module 430, a road-level map matching module 440, and an off-route determination module 450. After receiving an off-route confirmation request, the off-route confirmation system 400 may perform the following operations. At step 401, the off-route confirmation initiation module 410 sends to the distribution module 420 an off-route confirmation request carrying information about a sequence of trajectory points. At step 402, the distribution module 420 sends the sequence of trajectory points to the lane-level map matching module 430. At step 403, the distribution module 420 simultaneously sends the sequence of trajectory points to the road-level map matching module 440. At step 404, the lane-level map matching module 430 sends a lane-level matching result to the distribution module 420. At step 405, the road-level map matching module 440 sends a road-level matching result to the distribution module 420. At step 406, after determining whether the sequence of trajectory points meets a preset quality requirement and determining whether to update the road-level matching result, the distribution module 420 sends a final road-level matching result and lane-level matching result to the off-route determination module 450. At step 407, the off-route determination module 450 performs off-route confirmation based on any one of the above-described methods, and sends an off-route confirmation result to the distribution module 420. At step 408, the distribution module 420 sends the off-route confirmation result to the off-route confirmation initiation module 410, so that the off-route confirmation initiation module sends the off-route confirmation result to a client.

In some embodiments, the navigation method may further include: determining a fusion matching result based on the lane-level matching result and the road-level matching result in response to the off-route confirmation result indicating that a navigated object has deviated from the current navigation route, and in response to determining that the sequence of trajectory points meets the preset quality requirement, where the fusion matching result indicates a road on which the navigated object is currently located and is used for re-planning of the current navigation route.

Thus, after it is confirmed that there is already an off-route, if the sequence of trajectory points has passed the quality inspection, the fusion matching result is generated by using the lane-level matching result and the road-level matching result, serving as a benchmark for re-planning the navigation route, thereby improving the accuracy of a starting point of the re-planned navigation route.

In some embodiments, determining the fusion matching result based on the lane-level matching result and the road-level matching result may involve, in response to a lane matched to the last trajectory point in the lane-level matching result being inconsistent with a road matched to the last trajectory point in the road-level matching result (i.e., the lane is not in the road), mapping the lane matched to the last trajectory point to the road-level road network, so that a road corresponding to the lane is used as the fusion matching result, serving as the benchmark for re-planning the route.

In some embodiments, as shown in FIG. 5, determining the fusion matching result based on the lane-level matching result and the road-level matching result may include: step S501 of obtaining, from the road-level matching result, a first preset number of first candidate results with the highest matching confidence level for a last trajectory point in the sequence of trajectory points; step S502 of obtaining, from the lane-level matching result, a second candidate result with the highest matching confidence level for each of a last second preset number of trajectory points in the sequence of trajectory points; step S503 of performing a first operation sequentially for each of the last second preset number of trajectory points, starting from the last trajectory point, until the fusion matching result is obtained or the first operation is complete for each of the last second preset number of trajectory points, where the first operation may include: determining a third candidate result as the fusion matching result in response to determining that the first preset number of first candidate results comprise the third candidate result, where the third candidate result is consistent with the second candidate result corresponding to the trajectory point of the last second preset number of trajectory points; and step S504 of determining a candidate result with the highest matching confidence level among the first preset number of first candidate results as the fusion matching result in response to the fusion matching result not being obtained even after the first operation is complete for each of the last second preset number of trajectory points.

Thus, it is possible to fuse the matching results based on the existing parameters in the matching results, thereby saving computing resources while improving the accuracy of the starting point of the re-planned navigation route.

In some example embodiments, 5 (i.e., the first preset number) first candidate results with the highest matching confidence level for the last trajectory point may be obtained from the road-level matching result, where each of the first candidate results and the corresponding matching confidence level may be output by a road-level HMM model. Meanwhile, candidate results (second candidate results) with the highest matching confidence level for the last 3 (i.e., the second preset number) trajectory points may be obtained from the lane-level matching result, where each of the second candidate results and the corresponding matching confidence level may be output by a lane-level HMM model.

First, the second candidate result for the last trajectory point is used for determination. If the 5 first candidate results comprise the second candidate result, the second candidate result is determined as the fusion matching result. That is, a lane corresponding to the lane-level matching result with the highest matching confidence level for the last trajectory point is used as the fusion matching result. If the 5 first candidate results do not comprise the second candidate result, the determination is further repeated based on the second candidate result for the second-to-last trajectory point. If none of the 3 second candidate results are comprised in the 5 first candidate results, the road-level matching result obtained by the road-level map matching for the last trajectory point is still used as the fusion matching result.

It can be understood that the first preset number and the second preset number can be determined according to actual needs, which is not limited herein.

In some embodiments, the operation of obtaining the fusion matching result may be performed by the distribution module 420 in the off-route confirmation system 400. In addition, the fusion matching result may be sent together with the off-route confirmation result to the off-route confirmation initiation module 410, so that the off-route confirmation initiation module 410 sends the off-route confirmation result together with the fusion matching result to the client for route re-planning.

In some embodiments, as shown in FIG. 5, a navigation apparatus 500 is further provided. The navigation apparatus includes: an execution unit 510 configured to perform, in response to receiving an off-route confirmation request, road-level map matching and lane-level map matching based on a sequence of trajectory points in the off-route confirmation request, to correspondingly obtain a road-level matching result and a lane-level matching result, wherein the lane-level matching result comprises a lane-level path matched to the sequence of trajectory points; a judgment unit 520 configured to determine whether the sequence of trajectory points meets a preset quality requirement based on a trajectory point distribution feature of the sequence of trajectory points relative to the lane-level path; an update unit 530 configured to update the road-level matching result based on the lane-level matching result in response to determining that the sequence of trajectory points meets the preset quality requirement, and in response to determining that the lane-level matching result and the road-level matching result are inconsistent; and a first obtaining unit 540 configured to obtain an off-route confirmation result based on the road-level matching result updated and a current navigation route.

Operations performed by the units 510 to 540 in the navigation apparatus 500 and technical effects that these units can achieve are similar to those of steps S201 to S204 in the navigation method, and will not be described in detail herein.

In some embodiments, the trajectory point distribution feature may include a first feature corresponding to each trajectory point in the sequence of trajectory points, and the first feature includes at least one of: a distance between the trajectory point and the lane-level path, or an included angle between a trajectory line formed at the trajectory point by the sequence of trajectory points and the lane-level path.

In some embodiments, the judgment unit may be further configured to: determine whether the sequence of trajectory points meets the preset quality requirement based on the trajectory point distribution feature and a second feature of a last trajectory point in the sequence of trajectory points, wherein the second feature comprises at least one of: a matching confidence level of the last trajectory point with a lane matched to the last trajectory point in the lane-level path, a lane attribute of the lane, or connectivity between the last trajectory point and a preceding trajectory point of the last trajectory point.

In some embodiments, determining whether the lane-level matching result and the road-level matching result are consistent may include: determining, at a last trajectory point in the sequence of trajectory points, whether a lane in the lane-level matching result matched to the last trajectory point is on a road in the road-level matching result matched to the last trajectory point, to determine whether the lane-level matching result and the road-level matching result are consistent.

In some embodiments, the first obtaining unit may include: an input sub-unit configured to input the road-level matching result updated and the current navigation route into an off-route detection model, to obtain a first off-route identification result output by the off-route detection model; a first judgment sub-unit configured to determine whether a road-level path corresponding to the road-level matching result obtained by the road-level map matching is on the current navigation route, to obtain a second off-route identification result; a second judgment sub-unit configured to determine whether the lane-level path is on the current navigation route, to obtain a third off-route identification result; and a first determination sub-unit configured to determine the off-route confirmation result based on the first off-route identification result, the second off-route identification result, and the third off-route identification result.

In some embodiments, the first determination sub-unit may be further configured to: determine the off-route confirmation result as indicating that a navigated object is not off-route in response to any of the first off-route identification result, the second off-route identification result, or the third off-route identification result indicating that the navigated object has not deviated from the current navigation route; otherwise, determining the off-route confirmation result as indicating that the navigated object is off-route.

In some embodiments, the navigation apparatus may further include: a second obtaining unit configured to obtain the off-route confirmation result based on the road-level matching result obtained by the road-level map matching and the current navigation route in response to determining that the sequence of trajectory points does not meet the preset quality requirement.

In some embodiments, the navigation apparatus may further include: a determination unit configured to determine a fusion matching result based on the lane-level matching result and the road-level matching result in response to the off-route confirmation result indicating that a navigated object has deviated from the current navigation route, and in response to determining that the sequence of trajectory points meets the preset quality requirement, wherein the fusion matching result indicates a road on which the navigated object is currently located and is used for replanning the current navigation route.

In some embodiments, the determination unit may be configured to: obtain, from the road-level matching result, a first preset number of first candidate results with the highest matching confidence level for a last trajectory point in the sequence of trajectory points; obtain, from the lane-level matching result, a second candidate result with the highest matching confidence level for each of a last second preset number of trajectory points in the sequence of trajectory points; perform a first operation sequentially for each of the last second preset number of trajectory points, starting from the last trajectory point, until the fusion matching result is obtained or the first operation is complete for each of the last second preset number of trajectory points, wherein the first operation comprises: determining a third candidate result as the fusion matching result in response to determining that the first preset number of first candidate results comprise the third candidate result, wherein the third candidate result is consistent with the second candidate result corresponding to the trajectory point of the last second preset number of trajectory points; and determine a candidate result with the highest matching confidence level among the first preset number of first candidate results as the fusion matching result in response to the fusion matching result not being obtained even after the first operation is complete for each of the last second preset number of trajectory points.

In some embodiments, the navigation apparatus may further include: a sending unit configured to send the off-route confirmation result to a requester of the off-route confirmation request in response to the off-route confirmation result indicating that a navigated object has not deviated from the current navigation route.

In the technical solutions of the present disclosure, collection, storage, use, processing, transmission, provision, disclosure, etc. of user personal information involved all comply with related laws and regulations and are not against the public order and good morals.

According to embodiments of the present disclosure, an electronic device, a readable storage medium, and a computer program product are further provided.

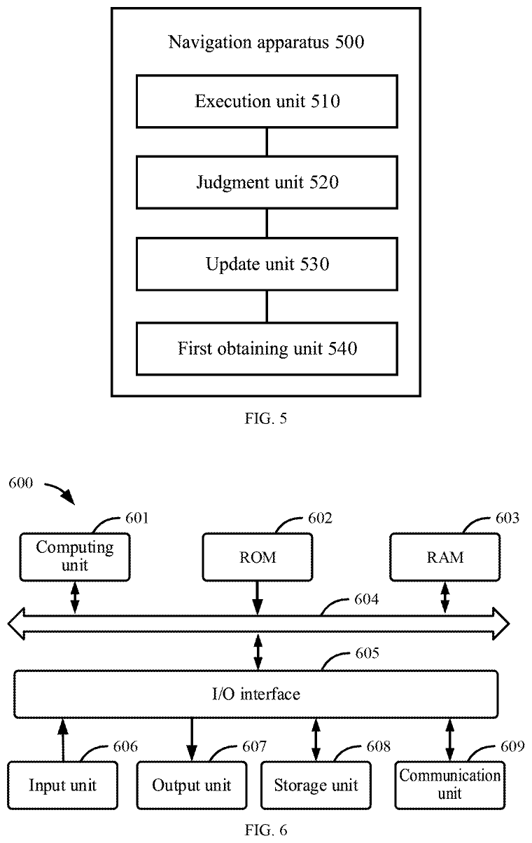

Referring to FIG. 6, a structural block diagram of an electronic device 600 will be described below, which can serve as a server or a client of the present disclosure and is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown in the present specification, their connections and relationships, and their functions are merely examples, and are not intended to limit the implementation of the present disclosure described and/or required herein.

As shown in FIG. 6, the electronic device 600 includes a computing unit 601, the computing unit may perform various appropriate actions and processing according to a computer program stored in a read-only memory (ROM) 602 or a computer program loaded from a storage unit 608 to a random access memory (RAM) 603. The RAM 603 may further store various programs and data required for the operation of the electronic device 600. The computing unit 601, the ROM 602, and the RAM 603 are connected to each other through a bus 604. An input/output (I/O) interface 605 is also connected to the bus 604.

A plurality of components in the electronic device 600 are connected to the I/O interface 605, including: an input unit 606, an output unit 607, the storage unit 608, and a communication unit 609. The input unit 606 may be any type of device capable of inputting information to the electronic device 600, the input unit 606 may receive input digit or character information and generate a key signal input related to user settings and/or function control of the electronic device, and may include, but is not limited to, a mouse, a keyboard, a touchscreen, a trackpad, a trackball, a joystick, a microphone, and/or a remote controller. The output unit 607 may be any type of device capable of presenting information, and may include, but is not limited to, a display, a speaker, a video/audio output terminal, a vibrator, and/or a printer. The storage unit 608 may include, but is not limited to, a magnetic disk and an optical disk. The communication unit 609 allows the electronic device 600 to exchange information/data with other devices via a computer network such as the Internet and/or various telecommunication networks, and may include, but is not limited to, a modem, a network interface card, an infrared communication device, a wireless communication transceiver, and/or a chipset, for example, a Bluetooth device, an 802.11 device, a Wi-Fi device, a WiMax device, and/or a cellular communication device.

The computing unit 601 may be various general-purpose and/or special-purpose processing components with processing and computing capabilities. Some examples of the computing unit 601 include, but are not limited to, a central processing unit (CPU), a graphics processing unit (GPU), various dedicated artificial intelligence (AI) computing chips, various computing units on which machine learning model algorithms run, a digital signal processor (DSP), and any appropriate processor, controller, microcontroller, etc. The computing unit 601 performs the various methods and processing described above, for example, the navigation method. For example, in some embodiments, the navigation method may be implemented as a computer software program tangibly embodied in a machine-readable medium, such as the storage unit 608. In some embodiments, a part or all of the computer program may be loaded and/or installed onto the electronic device 600 via the ROM 602 and/or the communication unit 609. When the computer program is loaded to the RAM 603 and executed by the computing unit 601, one or more steps of the navigation method may be performed. Alternatively, in other embodiments, the computing unit 601 may be configured, by any other appropriate means (for example, by means of firmware), to perform the navigation method.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logic device (CPLD), computer hardware, firmware, software, and/or a combination thereof. These various implementations may include implementation in one or more computer programs, where the one or more computer programs may be executed and/or interpreted on a programmable system including at least one programmable processor. The programmable processor may be a dedicated or general-purpose programmable processor that can receive data and instructions from a storage system, at least one input means, and at least one output means, and transmit data and instructions to the storage system, the at least one input apparatus, and the at least one output means.

Program codes used to implement the method of the present disclosure can be written in any combination of one or more programming languages. The program code may be provided for a processor or a controller of a general-purpose computer, a special-purpose computer, or other programmable data processing apparatuses, such that when the program code is executed by the processor or the controller, the functions/operations specified in the flowcharts and/or block diagrams are implemented. The program code may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing means (for example, a mouse or a trackball) through which the user can provide an input to the computer. Other categories of apparatuses can also be used to provide interaction with the user; for example, feedback provided to the user can be any form of sensory feedback (for example, visual feedback, auditory feedback, or tactile feedback); and an input from the user can be received in any form (including an acoustic input, a voice input, or a tactile input).

The systems and technologies described herein can be implemented in a computing system including a backend component (for example, as a data server), in a computing system including a middleware component (for example, an application server), in a computing system including a frontend component (for example, a user computer with a graphical user interface or a web browser through which the user can interact with the implementation of the systems and technologies described herein), or in a computing system including any combination of the backend component, the middleware component, and the frontend component. The components of the system can be connected to each other through digital data communication (for example, a communication network) in any form or medium. Examples of the communication network include: a local area network (LAN), a wide area network (WAN), and the Internet.

A computer system may include a client and a server. The client and the server are generally far away from each other and usually interact through a communication network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, successively, or in a different order, provided that the desired result of the technical solutions disclosed in the present disclosure can be achieved, which is not limited herein.

Although the embodiments or examples of the present disclosure have been described with reference to the accompanying drawings, it should be appreciated that the method, system, and device described above are merely example embodiments or examples, and the scope of the present disclosure is not limited by these embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A navigation method, comprising:
performing, in response to receiving an off-route confirmation request, road-level map matching and lane-level map matching based on a sequence of trajectory points in the off-route confirmation request, to correspondingly obtain a road-level matching result and a lane-level matching result, wherein the lane-level matching result comprises a lane-level path matched to the sequence of trajectory points;
determining whether the sequence of trajectory points meets a preset quality requirement based on a trajectory point distribution feature of the sequence of trajectory points relative to the lane-level path;
updating the road-level matching result based on the lane-level matching result in response to determining that the sequence of trajectory points meets the preset quality requirement, and in response to determining that the lane-level matching result and the road-level matching result are inconsistent; and
obtaining an off-route confirmation result based on the road-level matching result updated and a current navigation route.

2. The method according to claim 1, wherein the trajectory point distribution feature comprises a first feature corresponding to each trajectory point in the sequence of trajectory points, and the first feature comprises at least one of: a distance between the trajectory point and the lane-level path, or an included angle between a trajectory line formed at the trajectory point by the sequence of trajectory points and the lane-level path.

3. The method according to claim 1, wherein determining whether the sequence of trajectory points meets the preset quality requirement based on the trajectory point distribution feature of the sequence of trajectory points relative to the lane-level path comprises:
determining whether the sequence of trajectory points meets the preset quality requirement based on the trajectory point distribution feature and a second feature of a last trajectory point in the sequence of trajectory points, wherein the second feature comprises at least one of: a matching confidence level of the last trajectory point with a lane matched to the last trajectory point in the lane-level path, a lane attribute of the lane, or connectivity between the last trajectory point and a preceding trajectory point of the last trajectory point.

4. The method according to claim 1, wherein determining whether the lane-level matching result and the road-level matching result are consistent comprises:
determining, at a last trajectory point in the sequence of trajectory points, whether a lane in the lane-level matching result matched to the last trajectory point is on a road in the road-level matching result matched to the last trajectory point, to determine whether the lane-level matching result and the road-level matching result are consistent.

5. The method according to claim 1, wherein obtaining the off-route confirmation result based on the road-level matching result updated and the current navigation route comprises:
inputting the road-level matching result updated and the current navigation route into an off-route detection model, to obtain a first off-route identification result output by the off-route detection model;
determining whether a road-level path corresponding to the road-level matching result obtained by the road-level map matching is on the current navigation route, to obtain a second off-route identification result;
determining whether the lane-level path is on the current navigation route, to obtain a third off-route identification result; and
determining the off-route confirmation result based on the first off-route identification result, the second off-route identification result, and the third off-route identification result.

6. The method according to claim 5, wherein determining the off-route confirmation result based on the first off-route identification result, the second off-route identification result, and the third off-route identification result comprises:
determining the off-route confirmation result as indicating that a navigated object is not off-route in response to any of the first off-route identification result, the second off-route identification result, or the third off-route identification result indicating that the navigated object has not deviated from the current navigation route; otherwise, determining the off-route confirmation result as indicating that the navigated object is off-route.

7. The method according to claim 1, further comprising:
obtaining the off-route confirmation result based on the road-level matching result obtained by the road-level map matching and the current navigation route in response to determining that the sequence of trajectory points does not meet the preset quality requirement.

8. The method according to claim 1, further comprising:
determining a fusion matching result based on the lane-level matching result and the road-level matching result in response to the off-route confirmation result indicating that a navigated object has deviated from the current navigation route, and in response to determining that the sequence of trajectory points meets the preset quality requirement, wherein the fusion matching result indicates a road on which the navigated object is currently located and is used for replanning the current navigation route.

9. The method according to claim 8, wherein determining the fusion matching result based on the lane-level matching result and the road-level matching result comprises:
obtaining, from the road-level matching result, a first preset number of first candidate results with the highest matching confidence level for a last trajectory point in the sequence of trajectory points;
obtaining, from the lane-level matching result, a second candidate result with the highest matching confidence level for each of a last second preset number of trajectory points in the sequence of trajectory points;
performing a first operation sequentially for each of the last second preset number of trajectory points, starting from the last trajectory point, until the fusion matching result is obtained or the first operation is complete for each of the last second preset number of trajectory points, wherein the first operation comprises:
determining a third candidate result as the fusion matching result in response to determining that the first preset number of first candidate results comprise the third candidate result, wherein the third candidate result is consistent with the second candidate result corresponding to the trajectory point of the last second preset number of trajectory points; and
determining a candidate result with the highest matching confidence level among the first preset number of first candidate results as the fusion matching result in response to the fusion matching result not being obtained even after the first operation is complete for each of the last second preset number of trajectory points.

10. The method according to claim 1, further comprising:
sending the off-route confirmation result to a requester of the off-route confirmation request in response to the off-route confirmation result indicating that a navigated object has not deviated from the current navigation route.

11. An electronic device, comprising:
at least one processor; and
a memory communicatively connected to the at least one processor, wherein
the memory storing one or more programs configured to be executed by the one or more processors, the one or more programs including instructions for:
performing, in response to receiving an off-route confirmation request, road-level map matching and lane-level map matching based on a sequence of trajectory points in the off-route confirmation request, to correspondingly obtain a road-level matching result and a lane-level matching result, wherein the lane-level matching result comprises a lane-level path matched to the sequence of trajectory points;
determining whether the sequence of trajectory points meets a preset quality requirement based on a trajectory point distribution feature of the sequence of trajectory points relative to the lane-level path;
updating the road-level matching result based on the lane-level matching result in response to determining that the sequence of trajectory points meets the preset quality requirement, and in response to determining that the lane-level matching result and the road-level matching result are inconsistent; and
obtaining an off-route confirmation result based on the road-level matching result updated and a current navigation route.

12. The electronic device according to claim 11, wherein the trajectory point distribution feature comprises a first feature corresponding to each trajectory point in the sequence of trajectory points, and the first feature comprises at least one of: a distance between the trajectory point and the lane-level path, or an included angle between a trajectory line formed at the trajectory point by the sequence of trajectory points and the lane-level path.

13. The electronic device according to claim 11, wherein determining whether the sequence of trajectory points meets the preset quality requirement based on the trajectory point distribution feature of the sequence of trajectory points relative to the lane-level path comprises:
determining whether the sequence of trajectory points meets the preset quality requirement based on the trajectory point distribution feature and a second feature of a last trajectory point in the sequence of trajectory points, wherein the second feature comprises at least one of: a matching confidence level of the last trajectory point with a lane matched to the last trajectory point in the lane-level path, a lane attribute of the lane, or connectivity between the last trajectory point and a preceding trajectory point of the last trajectory point.

14. The electronic device according to claim 11, wherein determining whether the lane-level matching result and the road-level matching result are consistent comprises:
determining, at a last trajectory point in the sequence of trajectory points, whether a lane in the lane-level matching result matched to the last trajectory point is on a road in the road-level matching result matched to the last trajectory point, to determine whether the lane-level matching result and the road-level matching result are consistent.

15. The electronic device according to claim 11, wherein obtaining the off-route confirmation result based on the road-level matching result updated and the current navigation route comprises:
inputting the road-level matching result updated and the current navigation route into an off-route detection model, to obtain a first off-route identification result output by the off-route detection model;
determining whether a road-level path corresponding to the road-level matching result obtained by the road-level map matching is on the current navigation route, to obtain a second off-route identification result;
determining whether the lane-level path is on the current navigation route, to obtain a third off-route identification result; and
determining the off-route confirmation result based on the first off-route identification result, the second off-route identification result, and the third off-route identification result.

16. A non-transitory computer-readable storage medium, storing one or more programs comprising instructions that, when executed by one or more processors of a computing device, cause the computing device to perform operations comprising:
performing, in response to receiving an off-route confirmation request, road-level map matching and lane-level map matching based on a sequence of trajectory points in the off-route confirmation request, to correspondingly obtain a road-level matching result and a lane-level matching result, wherein the lane-level matching result comprises a lane-level path matched to the sequence of trajectory points;
determining whether the sequence of trajectory points meets a preset quality requirement based on a trajectory point distribution feature of the sequence of trajectory points relative to the lane-level path;
updating the road-level matching result based on the lane-level matching result in response to determining that the sequence of trajectory points meets the preset quality requirement, and in response to determining that the lane-level matching result and the road-level matching result are inconsistent; and
obtaining an off-route confirmation result based on the road-level matching result updated and a current navigation route.

17. The non-transient computer-readable storage medium according to claim 16, wherein the trajectory point distribution feature comprises a first feature corresponding to each trajectory point in the sequence of trajectory points, and the first feature comprises at least one of: a distance between the trajectory point and the lane-level path, or an included angle between a trajectory line formed at the trajectory point by the sequence of trajectory points and the lane-level path.

18. The non-transient computer-readable storage medium according to claim 16, wherein determining whether the sequence of trajectory points meets the preset quality requirement based on the trajectory point distribution feature of the sequence of trajectory points relative to the lane-level path comprises:
determining whether the sequence of trajectory points meets the preset quality requirement based on the trajectory point distribution feature and a second feature of a last trajectory point in the sequence of trajectory points, wherein the second feature comprises at least one of: a matching confidence level of the last trajectory point with a lane matched to the last trajectory point in the lane-level path, a lane attribute of the lane, or connectivity between the last trajectory point and a preceding trajectory point of the last trajectory point.

19. The non-transient computer-readable storage medium according to claim 16, wherein determining whether the lane-level matching result and the road-level matching result are consistent comprises:
determining, at a last trajectory point in the sequence of trajectory points, whether a lane in the lane-level matching result matched to the last trajectory point is on a road in the road-level matching result matched to the last trajectory point, to determine whether the lane-level matching result and the road-level matching result are consistent.

20. The non-transient computer-readable storage medium according to claim 16, wherein obtaining the off-route confirmation result based on the road-level matching result updated and the current navigation route comprises:
inputting the road-level matching result updated and the current navigation route into an off-route detection model, to obtain a first off-route identification result output by the off-route detection model;
determining whether a road-level path corresponding to the road-level matching result obtained by the road-level map matching is on the current navigation route, to obtain a second off-route identification result;
determining whether the lane-level path is on the current navigation route, to obtain a third off-route identification result; and
determining the off-route confirmation result based on the first off-route identification result, the second off-route identification result, and the third off-route identification result.
